(19) United States
(12) Patent Application Publication
(10) Pub. No.: US 2023/0017079 A1
(43) Pub. Date: Jan. 19, 2023

(54) Steering Wheel Table Device

(71) Applicant: Carlos Avila, Barstow, CA (US)

(72) Inventor: Carlos Avila, Barstow, CA (US)

(21) Appl. No.: 17/868,394

(22) Filed: Jul. 19, 2022

Related U.S. Application Data
(60) Provisional application No. 63/223,220, filed on Jul. 19, 2021.

(51) Int. Cl. B60N 3/00

(52) U.S. Cl. CPC B60N 3/005

(57) ABSTRACT

The present invention relates generally to the field of steering wheel attachments. More specifically, the present invention relates to a steering wheel table device that is primarily comprised of a body further comprised of a curved member, a horizontal cross member, at least one hinge and a tray member. The body of the device preferably resembles a tray table, and is flexible or semi-flexible such that it can be positioned over a steering wheel to create a compression force that retains the device onto the steering wheel. The device is also comprised of a tray member on which food, electronics or other equipment can be placed to create a workstation in a vehicle. In this manner, the device can be applied to the steering wheel of any vehicle, such that a user can perform work tasks in a vehicle more comfortably and efficiently.

### CROSS-REFERENCE TO RELATED APPLICATION

The present application claims priority to, and the benefit of, U.S. Provisional Application No. 63/223,220, which was filed on Jul. 19, 2021 and is incorporated herein by reference in its entirety.

### FIELD OF THE INVENTION

The present invention relates generally to the field of steering wheel attachments. More specifically, the present invention relates to a steering wheel table device that is primarily comprised of a body further comprised of a curved member, a horizontal cross member, at least one hinge and a tray member. The body of the device preferably resembles a tray table and is flexible or semi-flexible such that it can be positioned over a steering wheel to create a compression force that retains the device onto the steering wheel. The device is also comprised of a tray member on which food, electronics or other equipment can be placed to create a workstation in a vehicle. In this manner, the device can be applied to the steering wheel of any vehicle such that a user can perform work tasks in a vehicle more comfortably and efficiently. Accordingly, the present disclosure makes specific reference thereto. Nonetheless, it is to be appreciated that aspects of the present invention are also equally applicable to other like applications, devices and methods of manufacture.

### BACKGROUND

With the rapid pace of technological advancement and an ever-changing world, traditional workplaces are becoming less common. While offices with cubicles and desks are still prevalent, people are trending towards working from home and other non-traditional locations such as from their vehicles, from a local coffee shop, etc. However, these non-traditional workplaces can pose a challenge as they contain limited working space and an environment that may not be ergonomically-friendly to work tasks being performed. Further, balancing electronics such as laptops, tablets and phones with food, papers and personal items may be difficult with the limited space on-the-go and non-traditional workers experience.

Therefore, there exists a long-felt need in the art for a steering wheel table device. There also exists a long-felt need in the art for a steering wheel table device that provides a lightweight and durable workstation compatible with any type of vehicle. Further, there exists a long-felt need in the art for a steering wheel table device that can act as a portable desk for on-the-go workers. In addition, there exists a long-felt need in the art for a steering wheel table device that is collapsible such that it can be transported and stored easily.

The subject matter disclosed and claimed herein, in one embodiment thereof, comprises a steering wheel table device. The device is primarily comprised of a body further comprised of a curved member, a horizontal cross member, at least one hinge and a tray member. The body of the device preferably resembles a tray table and is flexible or semi-flexible such that it can be positioned over a steering wheel to create a compression force that retains the device onto the steering wheel. The device is also comprised of a tray member on which food, electronics or other equipment can be placed to create a workstation in a vehicle. In this manner, the device can be applied to the steering wheel of any vehicle such that a user can work in a vehicle more comfortably and efficiently.

In this manner, the steering wheel table device of the present invention accomplishes all the forgoing objectives and provides an improved means to work from a vehicle. Further, the device can universally attach to the steering wheel of any vehicle to set up a lightweight and durable workstation such that people who commonly work from their vehicles have a place to rest electronics and other items while being used. In addition, the device can collapse into itself to be transported into and out of vehicles and placed in storage in a safe and efficient manner.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a steering wheel table device. The device is primarily comprised of a body further comprised of a curved member, a horizontal cross member, at least one hinge and a tray member. In differing embodiments, the body may have the general appearance of a tray table. The body may also be made of a plurality of materials commonly used in vehicles. However, the body is preferably made of a flexible or semi-flexible plastic material. In addition, any surface of the body may be comprised of a plurality of indicia such as patterns, logos, emblems, images, symbols, designs, letters, words, characters, animals, advertisements, brands, etc.

The body also has a curved member that removably attaches to a steering wheel of a vehicle. The curved member may be rigid or flexible such that it can attach to a steering wheel of any style or size by fitting securely over a portion of the steering wheel. The interior surface of the curved member may be soft and smooth so as to not damage the steering wheel. In addition, the exterior surface of the curved member may be textured to aid in gripping the curved member.

The curved member and a tray member are attached via a horizontal cross member. The horizontal cross member is rigid to add support to the device. The horizontal cross member is fixedly-attached to the curved member, whereas the horizontal cross member may be fixedly or removably-attached to the tray member via at least one hinge. The at least one hinge allows the tray member to fold into the curved member, aiding in transportation and storage of the device. The tray member is further comprised of a top surface in which items, such as laptops, tablets, food, drink, etc., may sit. The tray member may act as a workstation such that a top surface of the tray member prevents items from sliding off the tray member by being textured or made of an anti-slip material.

Accordingly, the steering wheel table device of the present invention is particularly advantageous as it provides an improved means to work from a vehicle. Further, the device is foldable to allow for simple and efficient transportation into and out of vehicles and storage placement. In addition, the device universally attaches to the steering wheel of any vehicle to set up a lightweight and durable workstation, such that people who commonly work from their vehicles have a place to rest electronics, documents, food and other items while being used. In this manner, the steering wheel table device overcomes the limitations of existing methods of working from vehicles known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a steering wheel table device of the present invention in a folded state in accordance with the disclosed architecture;

FIG. 2 illustrates a perspective view of one potential embodiment of a steering wheel table device of the present invention in an unfolded state in accordance with the disclosed architecture; and

FIG. 3 illustrates a perspective view of one potential embodiment of a steering wheel table device of the present invention in an unfolded state and while attached to a steering wheel in accordance with the disclosed architecture.

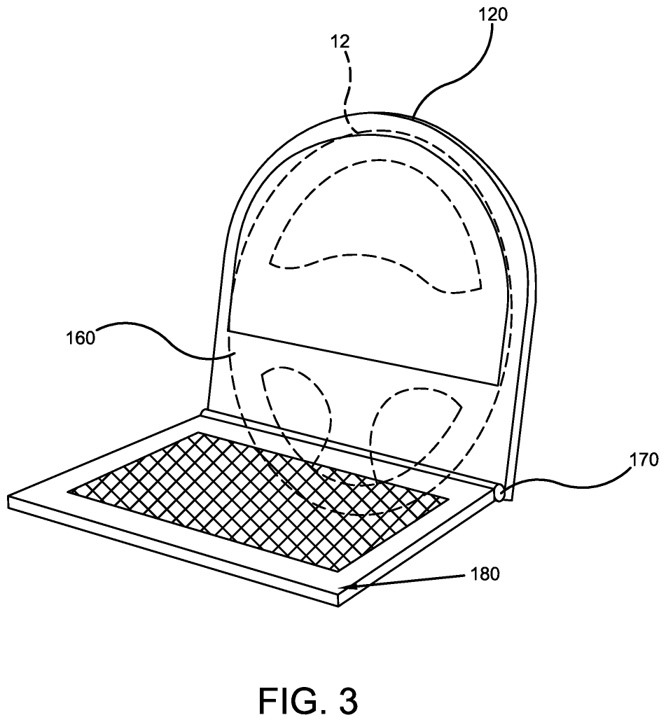

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention, and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a steering wheel table device. There also exists a long-felt need in the art for a steering wheel table device that provides a lightweight and durable workstation, compatible with any type of vehicle. Further, there exists a long-felt need in the art for a table device that can act as a portable desk for on-the-go workers. In addition, there exists a long-felt need in the art for a steering wheel table device that is collapsible such that it can be transported and stored easily.

The present invention, in one exemplary embodiment, is comprised of a steering wheel table device that allows a person that commonly works from his or her vehicle to set up a workstation for electronics, food and other items necessary for completing work-related tasks. The device is primarily comprised of a body further comprised of a curved member, a horizontal cross member, at least one hinge, and a tray member. In differing embodiments, the body may have the appearance of a personal tray table made in a plurality of differing shapes and sizes. The body may also be made of a plurality of materials such as wood or metal, but in the preferred embodiment the body is made of a flexible or semi-flexible plastic material. In addition, any surface of the body may be comprised of a plurality of indicia such as patterns, logos, emblems, images, symbols, designs, letters, words, characters, animals, advertisements, brands, etc.

Further, the body has a curved member that removably-attaches to a steering wheel. In one potential embodiment, the curved member may be made of a rigid plastic such that the curved member forms a press fit attachment to a steering wheel of a vehicle. In another potential embodiment, the curved member may be made of a flexible or semi-flexible plastic such as silicon, such that the curved member may be stretched over a steering wheel and be able to interface with varying types and sizes of steering wheels. An exterior surface of the curved member may be comprised of any indicia described supra. The exterior surface may additionally be made of a textured material to aid in grip or comfort. The curved member is further comprised of an interior surface that may be made of a smooth material, such as felt, to prevent scratching and other forms of damage to the steering wheel.

A rigid horizontal cross member attaches the curved member to a tray member of the device. The horizontal cross member is fixedly-attached to the curved member and provides structural support to the device. The horizontal cross member is fixedly or removably-attached to the tray member via at least one hinge. The at least one hinge allows the device to collapse into itself to ease in transportation and storage. The tray member, from an already collapsed position, may unfold down to a sturdy stopping point, such that the tray member can hold food, drink and equipment without failure. In one potential embodiment, the at least one hinge may have locking points at different degrees of angular rotation such that the tray member can sturdily hold various positions. Thus, the angle of the tray member may be customizable by the user. The tray member is also comprised of a top surface that may prevent items from sliding off the device by being textured or made from an anti-slip material such as rubber.

Accordingly, the steering wheel table device of the present invention accomplishes all the forgoing objectives and provides a means to work from a vehicle. Further, the device can universally attach to the steering wheel of any vehicle to set up a lightweight and durable workstation such that people who commonly work from their vehicles have a place to rest electronics and other items while being used. In addition, the device can collapse into itself to be transported into and out of vehicles and placed in storage in a safe and efficient manner. In this manner, the steering wheel table device overcomes the limitations of existing headstones known in the art.

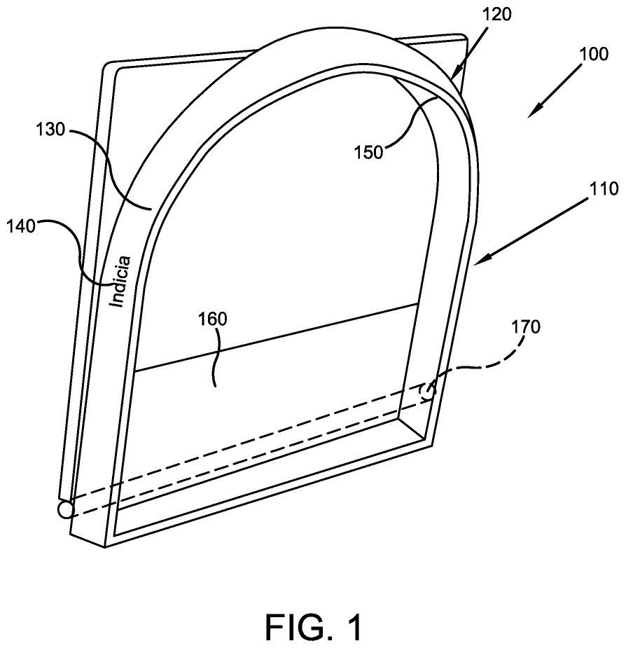

Referring initially to the drawings, FIG. 1 illustrates a perspective view of one potential embodiment of a steering wheel table device 100 of the present invention in a folded state in accordance with the disclosed architecture. The device 100 is primarily comprised of a body 110 further comprised of a curved member 120, a horizontal cross member 160, at least one hinge 170 and a tray member 180. In differing embodiments, the body 110 may have the general appearance of a tray table and may be of a plurality of differing shapes and sizes. Further, the body 110 may be made of a plurality of materials such as wood or metal, but is preferably made of a flexible or semi-flexible plastic material such as, but not limited to, an acrylic, polyvehiclebonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, etc. In addition, the body 110 may be transparent, semi-transparent or opaque in differing embodiments. Furthermore, any surface 130, 150, 190 of the body 110 may be comprised of any number of indicia 140 in the form of patterns, logos, emblems, images, symbols, designs, letters, words, characters, animals, advertisements, brands, etc.

In the preferred embodiment of the device 100 the body 110 has a curved member 120 that removably attaches to and around a steering wheel 12 of a car, truck, SUV, or other vehicle with a steering wheel 12. The curved member 120 may be rigid or flexible, such that the curved member 120 can fit around a steering wheel 12 and support the device 100 and other items placed on the tray member 180. In an embodiment of the device 100 in which the curved member 120 is flexible, the curved member 120 may be stretched over a steering wheel 12. In this manner, the device 100 may be able to fit more types and sizes of steering wheels 12 in vehicles other that vehicles such as, but not limited to, an ATV, a tractor, a golf cart, a UTV, a side-by-side, a boat or any other vehicle with a steering wheel 12 known in the art. The curved member 120 is further comprised of an exterior surface 130 and an interior surface 150. The exterior surface 130 of the curved member 120 may be textured to aid in gripping the device 100 as it sits over the steering wheel 12. The interior surface 150 of the curved member 120 may be made of a smooth or soft material, such as felt or other similar material, to prevent the steering wheel 12 from being damaged in any way by the application of the curved member 120.

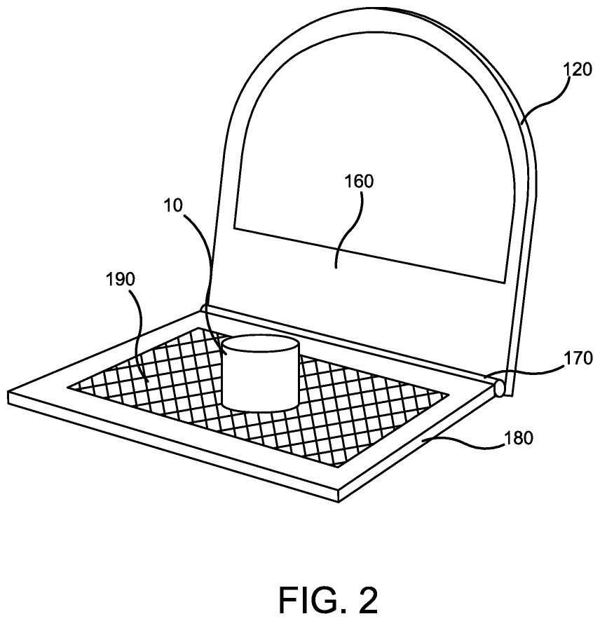

FIG. 2 illustrates a perspective view of one potential embodiment of a steering wheel table device 100 of the present invention in an unfolded state in accordance with the disclosed architecture. A horizontal cross member 160 connects the curved member 120 to a tray member 180 of the device 100. The horizontal cross member 160 is rigid such that it provides support to the device 100 and is fixedly-attached to the curved member 120. The horizontal cross member 160 is fixedly or removably-attached to the tray member 180 via an at least one hinge 170. The tray member 180, in the preferred embodiment, is rectangular, but may resemble any shape, such as a circle, oval, square, triangle, trapezoid, or any other shape, and thickness in differing embodiments. The at least one hinge 170 could be any hinge type known in the art such as, but not limited to, an offset blind hinge, a knuckle hinge, a butt hinge, a rising butt hinge, a gravity pivot hinge, a ball bearing hinge, a barrel hinge, a concealed hinge, a knife hinge, a piano hinge, a strap hinge, a pivot hinge, a gas-piston hinge, an injection molded hinge, a locking hinge, etc. The at least one hinge 170 allows the device to fold open and closed. The folded and closed position of the device 100 (as best seen in FIG. 1) is best for transporting and storing the device 100 whereas the unfolded and open position of the device 100 allows the device 100 to be used as a tray or workstation while attached to a steering wheel 12.

In an unfolded position, the tray member 180 or the at least one hinge 170 has at least one stopping point to prevent further rotation, such that the tray 180 is parallel with a ground surface. In one potential embodiment, the at least one hinge 170 may have multiple locking points or stopping points at different degrees of angular rotation such that the user may decide which position best suits his or her needs. The tray member 180 is further comprised of a top surface 190 where objects 10 such as laptops, tablets, plates, bowls, drinks, papers, etc. may rest. The top surface 190 may also be textured or made from a non-slip material to prevent any items from sliding off the device 100.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “steering wheel table device” and “device” are interchangeable and refer to the steering wheel table device 100 of the present invention.

Notwithstanding the forgoing, the steering wheel table device 100 of the present invention and its various components can be of any suitable size and configuration as is known in the art without affecting the overall concept of the invention, provided that they accomplish the above-stated objectives. One of ordinary skill in the art will appreciate that the size, configuration and material of the steering wheel table device 100 as shown in the FIGS. are for illustrative purposes only, and that many other sizes and shapes of the steering wheel table device 100 are well within the scope of the present disclosure. Although the dimensions of the steering wheel table device 100 are important design parameters for user convenience, the steering wheel table device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A steering wheel table device comprising:
a body further comprised of:
a curved member;
a horizontal cross member;
at least one hinge; and
a tray member.

2. The steering wheel table device of claim 1, wherein the curved member is sized and configured to removably attach around a steering wheel of a vehicle.

3. The steering wheel table device of claim 1, wherein the horizontal cross member is rigid and is attached to the curved member to provide support to the steering wheel table device.

4. The steering wheel table device of claim 1, wherein the at least one hinge attaches the tray member to the horizontal cross member.

5. The steering wheel table device of claim 4, wherein the tray member is foldable.

6. The steering wheel table device of claim 5, wherein the tray member is in an unfolded position when the tray member is parallel with a ground surface.

7. A steering wheel table device comprising:
a body further comprised of:
a curved member that is sized and configured to removably attach around a steering wheel of a vehicle;
a horizontal cross member attached to the curved member;
a folding tray member; and
at least one hinge that attaches the tray member to the horizontal cross member so that the tray member is repositionable relative to the horizontal cross member.

8. The steering wheel table device of claim 7, wherein the curved member is flexible.

9. The steering wheel table device of claim 7, wherein the horizontal cross member provides support to the steering wheel table device.

10. The steering wheel table device of claim 7, wherein when the tray member is in an unfolded position, the tray member is parallel with a ground surface.

11. A steering wheel table device comprising:
a body further comprised of:
a curved member that is sized and configured to removably attach around a steering wheel, wherein the curved member is further comprised of an exterior surface and an interior surface;
a horizontal cross member attached to the curved member;
a folding tray member further comprised of a top surface; and
at least one hinge that attaches the tray member to the horizontal cross member and that allows the tray member to be repositioned between a folded position and an unfolded position.

12. The steering wheel table device of claim 11, wherein the curved member is rigid.

13. The steering wheel table device of claim 11, wherein the horizontal cross member provides support to the steering wheel table device.

14. The steering wheel table device of claim 11, the at least one hinge has at least one stopping point to prevent further rotation of the at least one hinge such that tray member is in a position parallel with a ground surface

15. The steering wheel table device of claim 14, wherein the tray member is sized and configured to receive and support an object.

16. The steering wheel table device of claim 15, wherein the top surface of the tray member is textured or is made from a non-slip material to prevent the object from sliding off the top surface.

17. The steering wheel table device of claim 11, wherein the exterior surface of the curved member is textured.

18. The steering wheel table device of claim 11, wherein the interior surface of the curved member is comprised of a soft material that does not damage the steering wheel that the curved member is attached to.

19. The steering wheel table device of claim 11, wherein the tray member is a select one of a rectangular shape, a circular shape, an oval shape, a square shape, a triangle shape and a trapezoid shape.

20. The steering wheel table device of claim 11, wherein the at least one hinge is a select one of an offset blind hinge, a knuckle hinge, a butt hinge, a rising butt hinge, a gravity pivot hinge, a ball bearing hinge, a barrel hinge, a concealed hinge, a knife hinge, a piano hinge, a strap hinge, a pivot hinge, a gas-piston hinge, an injection molded hinge and a locking hinge.
